(19) United States
(12) Patent Application Publication
(10) Pub. No.: US 2026/0329360 A1
(43) Pub. Date: Oct. 22, 2026

(54) METHOD AND SYSTEM FOR POWER CONTROL BASED ON WIRELESS SIGNAL TECHNOLOGY

(71) Applicant: AMERICAN BEE SMART HOME, MAMARONECK, NY (US)

(72) Inventor: Guoqing ZHU, Shenzhen (CN)

(73) Assignee: AMERICAN BEE SMART HOME, MAMARONECK, NY (US)

(21) Appl. No.: 19/406,979

(22) Filed: Dec. 3, 2025

(30) Foreign Application Priority Data
Apr. 22, 2025 (CN) 2025105044907

(51) Int. Cl. G06F 1/3203; G05B 13/04

(52) U.S. Cl. CPC G06F 1/3203; G05B 13/042; H02J 13/12

(57) ABSTRACT

This disclosure relates to the technical field of power control, and discloses a method and a system for power control based on wireless signal technology. The method includes: performing high-frequency harmonic component stripping processing on an original environmental reflection signal to obtain an electromagnetic characteristic signal; identifying a direct wave component and a reflected wave component of the electromagnetic characteristic signal to calculate a signal propagation delay and a signal attenuation coefficient of the electromagnetic characteristic signal in a signal transmission path; constructing a three-dimensional electromagnetic field model of a target area, identifying a harmonic characteristic of a power supply device in the target area, detecting and monitoring a backscatter signal in real time based on the harmonic characteristic to analyze an energy absorption characteristic of the power supply device, and constructing an energy consumption demand curve of the power supply device based on the energy absorption characteristic.

### CROSS-REFERENCE TO RELATED APPLICATIONS

The application claims priority to Chinese patent application No. 2025105044907, filed on Apr. 22, 2025, the entire contents of which are incorporated herein by reference.

### TECHNICAL FIELD

This disclosure relates to a method and a system for power control based on wireless signal technology, belonging to the technical field of power control.

### BACKGROUND

Power control refers to a process of regulating and managing the supply, distribution, and use of electrical energy, which is widely applied in various fields such as industrial production, intelligent buildings, consumer electronics, and transportation. In an industrial scenario, through power control, the stable operation of various production devices can be ensured, and in the field of intelligent buildings, efficient power supply management for systems such as lighting and air conditioning can be achieved. With the increasing complexity and diversification of modern technological application scenarios, the drawbacks of traditional power control methods have gradually emerged. For example, physical wiring limits an installation location and flexibility of a device, and a wired communication protocol has a lagging response speed when coping with rapidly changing control requirements, making it impossible to dynamically adjust a power control strategy in real time according to environmental changes, user requirements, etc.

Currently, the intelligent means for power control are mainly based on wired connection-based automatic control, and a power supply is controlled according to a preset logic instruction through a wired communication line. Although this method can achieve a certain degree of automatic operation, it is unable to perceive the power supply device in real time when facing constantly changing power consumption environments, fluctuations in device loads, and diversified power consumption demands of the user. This results in the failure to accurately match power supply with an actual power consumption demand, leading to the inability to achieve accurate control of the power.

### SUMMARY

This disclosure provides a method and a system for power control based on wireless signal technology, with the main purpose of improving the accuracy of power control.

To achieve the above purpose, the method for power control based on wireless signal technology provided by this disclosure includes:
transmitting a composite microwave signal to a target area by using a pre-configured phased array, and then receiving an echo signal reflected back from the target area to obtain an original environmental reflection signal; and performing high-frequency harmonic component stripping processing on the original environmental reflection signal to obtain an electromagnetic characteristic signal;
performing multipath delay analysis on the electromagnetic characteristic signal to identify a direct wave component and a reflected wave component of the electromagnetic characteristic signal; and calculating, based on the direct wave component and the reflected wave component, a signal propagation delay and a signal attenuation coefficient of the electromagnetic characteristic signal in a signal transmission path;
constructing a three-dimensional electromagnetic field model of the target area based on the signal propagation delay and the signal attenuation coefficient; identifying a harmonic characteristic of a power supply device in the target area by using the three-dimensional electromagnetic field model; detecting and monitoring a backscatter signal of the power supply device in real time based on the harmonic characteristic; analyzing an energy absorption characteristic of the power supply device based on the backscatter signal; and constructing an energy consumption demand curve of the power supply device based on the energy absorption characteristic; and
optimizing, based on the energy consumption demand curve, a power supply time series scheme for the power supply device to obtain a multi-target load distribution strategy for the power supply device; performing parameter adjustment on the pre-configured phased array based on the multi-target load distribution strategy to obtain an adjusted signal device; and performing power control on the power supply device by using the adjusted signal device.

Optional, the performing high-frequency harmonic component stripping processing on the original environmental reflection signal to obtain an electromagnetic characteristic signal includes:
performing band-pass filtering processing on the original environmental reflection signal to obtain a baseband purification signal;
performing second-order intermodulation distortion elimination processing on the baseband purification signal to obtain an intermodulation suppression signal;
performing third-order intermodulation interference elimination processing on the intermodulation suppression signal to obtain an intermodulation compensation signal;
performing nonlinear residual compensation on the intermodulation compensation signal to obtain an enhanced signal; and
performing harmonic component reconstruction on the enhanced signal to obtain the electromagnetic characteristic signal.

Optional, the performing multipath delay analysis on the electromagnetic characteristic signal to identify a direct wave component and a reflected wave component of the electromagnetic characteristic signal includes:
performing a short-time Fourier transform on the electromagnetic characteristic signal to obtain a time-frequency matrix;
constructing a sparse dictionary of the electromagnetic characteristic signal based on the time-frequency matrix;
performing sparse reconstruction on a multipath component in the sparse dictionary to obtain a sparse coefficient vector; and
identifying the direct wave component and the reflected wave component of the electromagnetic characteristic signal according to the sparse coefficient vector.

Optional, the calculating, based on the direct wave component and the reflected wave component, a signal propagation delay and a signal attenuation coefficient of the electromagnetic characteristic signal in a signal transmission path includes:
performing peak detection on the direct wave component and the reflected wave component to obtain a direct wave arrival time and a reflected wave arrival time;
calculating, based on the direct wave arrival time and the reflected wave arrival time, the signal propagation delay of the electromagnetic characteristic signal in the signal transmission path by using the following formula:

T=W_{d}×(t_{d}−t₀)+Wᵣ×(tᵣ−t₀)
where T represents the signal propagation delay; w_{d} represents a weight of the direct wave component; wᵣ represents a weight of the reflected wave component; t₀ represents a transmission time of the electromagnetic characteristic signal; t_{d} represents the direct wave arrival time; and tᵣ represents the reflected wave arrival time;
calculating a signal attenuation coefficient of the direct wave component by using the following formula to obtain a first signal attenuation coefficient:

$${α}_{d} = 10 {log}_{10} ( \frac{{P}_{t}}{{P}_{rd}} ) - P ( d )$$

where α_{d} represents the first signal attenuation coefficient; Pₜ represents power of a transmitted signal corresponding to the direct wave component; P_{rd} represents received power of the direct wave component; P(d) represents path loss of the direct wave component;
calculating a signal attenuation coefficient of the reflected wave component by using the following formula to obtain a second signal attenuation coefficient:

$${α}_{r} = 10 {log}_{10} ( \frac{{P}_{t}}{{P}_{rr}} ) - P ( r )$$

where αᵣ represents the second signal attenuation coefficient; Pₜ represents power of a transmitted signal corresponding to the direct wave component; Pᵣᵣ represents received power of the reflected wave component; P(r) represents path loss of the reflected wave component; and
performing weighting processing on the first signal attenuation coefficient and the second signal attenuation coefficient to determine the signal attenuation coefficient of the electromagnetic characteristic signal in the signal transmission path.

Optional, the constructing a three-dimensional electromagnetic field model of the target area based on the signal propagation delay and the signal attenuation coefficient includes:
converting the target area into a three-dimensional voxel grid;
reconstructing a propagation path of the target area based on the three-dimensional voxel grid to obtain a reconstructed path set;
performing environmental CAD matching on the reconstructed path set to obtain a matched path set;
calculating, by using the signal propagation delay and the signal attenuation coefficient, a field intensity distribution of different matched paths in the matched path set to obtain a field intensity matrix;
constructing a three-dimensional heat map of the target area based on the field intensity matrix; and
performing digital twin processing on the three-dimensional heat map to obtain the three-dimensional electromagnetic field model.

Optional, the identifying a harmonic characteristic of a power supply device in the target area by using the three-dimensional electromagnetic field model includes:
performing coordinate matching between the three-dimensional electromagnetic field model and the power supply device in the target area to obtain a device coordinate set;
identifying a spectrum characteristic of the device coordinate set at a position corresponding to the three-dimensional electromagnetic field model;
performing characteristic matching between the spectrum characteristic and a pre-configured device fingerprint database to obtain a matched characteristic; and
identifying the harmonic characteristic of the power supply device in the target area based on the matched characteristic.

Optional, the analyzing an energy absorption characteristic of the power supply device based on the backscatter signal includes:
performing direct current component removal processing on the backscatter signal to obtain a direct current removed signal;
identifying a frequency domain characteristic and a time domain characteristic of the direct current removed signal;
analyzing, based on the frequency domain characteristic, an absorption response of the power supply device to electromagnetic waves of different frequencies to obtain a frequency absorption characteristic;
constructing an energy absorption model of the power supply device based on the time domain characteristic;
analyzing energy absorption efficiency of the power supply device under different working conditions by using the energy absorption model; and
identifying the energy absorption characteristic of the power supply device based on the frequency absorption characteristic and the energy absorption efficiency.

Optional, the constructing an energy consumption demand curve of the power supply device based on the energy absorption characteristic includes:
performing time series alignment processing on the energy absorption characteristic to obtain a time series absorption characteristic;
performing working condition segmentation labeling processing on the time series absorption characteristic to obtain a labeled characteristic;
performing, based on the labeled characteristic, vectorization processing on the labeled characteristic to obtain a labeled matrix;
constructing an energy consumption demand prediction model of the power supply device by using the labeled matrix;
analyzing a future energy consumption distribution of the power supply device based on the energy consumption demand prediction model; and
constructing the energy consumption demand curve of the power supply device based on the future energy consumption distribution.

Optional, the optimizing, based on the energy consumption demand curve, a power supply time series scheme for the power supply device to obtain a multi-target load distribution strategy for the power supply device includes:
segmenting the energy consumption demand curve to obtain a segmented curve;
performing overload detection on the segmented curve to obtain an overload curve;
performing load adjustment on the overload curve to obtain an adjusted curve;
constructing a preliminary load distribution strategy of the power supply device based on the adjusted curve;
identifying an operation constraint and a power supply requirement of the power supply device; and
optimizing, based on the operation constraint and the power supply requirement, the preliminary load distribution strategy to obtain the multi-target load distribution strategy.

To achieve the above purpose, this disclosure further provides a system for power control based on wireless signal technology, where the system includes:
a signal processing module, configured to transmit a composite microwave signal to a target area by using a pre-configured phased array, and then receive an echo signal reflected back from the target area to obtain an original environmental reflection signal; and perform high-frequency harmonic component stripping processing on the original environmental reflection signal to obtain an electromagnetic characteristic signal;
a signal analysis module, configured to perform multipath delay analysis on the electromagnetic characteristic signal to identify a direct wave component and a reflected wave component of the electromagnetic characteristic signal; and calculate, based on the direct wave component and the reflected wave component, a signal propagation delay and a signal attenuation coefficient of the electromagnetic characteristic signal in a signal transmission path;
a device energy consumption analysis module, configured to construct a three-dimensional electromagnetic field model of the target area based on the signal propagation delay and the signal attenuation coefficient; identify a harmonic characteristic of a power supply device in the target area by using the three-dimensional electromagnetic field model; detect and monitor a backscatter signal of the power supply device in real time based on the harmonic characteristic; analyze an energy absorption characteristic of the power supply device based on the backscatter signal; and construct an energy consumption demand curve of the power supply device based on the energy absorption characteristic; and
a power control module, configured to optimize, based on the energy consumption demand curve, a power supply time series scheme for the power supply device to obtain a multi-target load distribution strategy for the power supply device; perform parameter adjustment on the pre-configured phased array based on the multi-target load distribution strategy to obtain an adjusted signal device; and perform power control on the power supply device by using the adjusted signal device.

Compared with the problems described in the background, in the embodiments of this disclosure, the pre-configured phased array is used to transmit the composite microwave signal to the target area and receive the echo, so that the original environmental reflection signal is obtained, and purification processing is performed on the signal to highlight an intrinsic electromagnetic characteristic, thereby improving the analysis accuracy. Further, in this disclosure, the multipath delay analysis is performed on the electromagnetic characteristic signal through methods such as the short-time Fourier transform, the sparse dictionary construction, and the sparse reconstruction, so that the direct wave component and the reflected wave component are identified, the signal propagation path is understood, and the signal propagation delay and the attenuation coefficient are calculated based on this, so as to locate the target area and assist the device in selecting a parameter such as a transmission power, thereby ensuring communication quality and stability. Further, in this disclosure, the harmonic characteristic of the power supply device is identified by constructing the three-dimensional electromagnetic field model, so as to monitor the backscatter signal in real time, obtain dynamic device information, and construct the energy absorption model of the device to learn the energy utilization efficiency and consumption of the device, thereby constructing the energy consumption demand curve of the power supply device to analyze future energy consumption distribution, etc., displaying a change law of device energy consumption and providing a basis for power supply and device scheduling. Still further, in this disclosure, a multi-target load distribution strategy is constructed by considering the operation constraint and the power supply requirement of the power supply device, so as to achieve reasonable load distribution, and then the phased array parameter is adjusted, so that an operation state of the device can be controlled more accurately, and power control is performed on the power supply device by using the adjusted signal device, and a phased array beam is dynamically controlled by matching the device position and the energy consumption demand in real time, thereby achieving refined control. Therefore, according to this disclosure, the accuracy of power control can be improved.

### BRIEF DESCRIPTION OF THE DRAWINGS

FIG. 1 is a schematic flowchart of a method for power control based on wireless signal technology according to an embodiment of this disclosure; and

FIG. 2 is a schematic module diagram of a system for power control based on wireless signal technology according to an embodiment of this disclosure.

The purpose realization, functional features, and advantages of this disclosure will be further described with reference to embodiments and the accompanying drawings.

### DETAILED DESCRIPTION OF THE EMBODIMENTS

It should be understood that the embodiments described herein are only intended to explain rather than limit this disclosure.

An embodiment of this disclosure provides a method for power control based on wireless signal technology. The execution subject of the method for power control based on wireless signal technology includes, but is not limited to, at least one of electronic device such as a server and a terminal that can be configured to execute the method provided by the embodiment of this disclosure. In other words, the method for power control based on wireless signal technology may be executed by software or hardware installed in a terminal device or a server device. The server includes, but is not limited to: a single server, a server cluster, a cloud server, or a cloud server cluster, etc.

### Embodiment 1

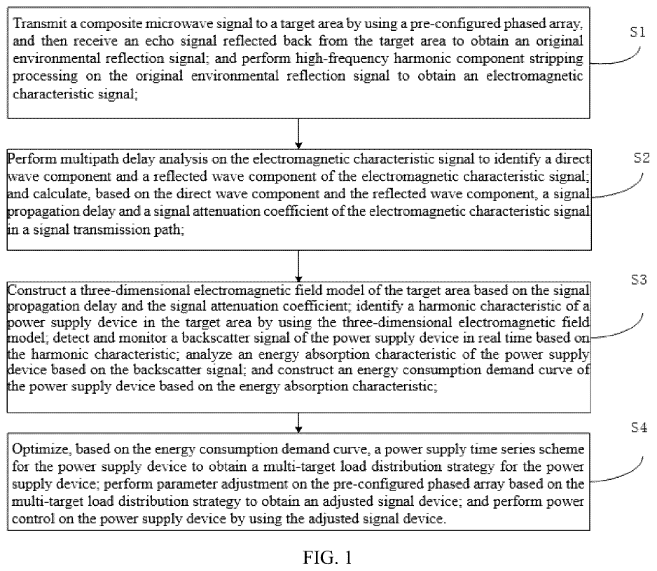

As shown in FIG. 1, it is a schematic flowchart of a method for power control based on wireless signal technology according to an embodiment of this disclosure. In this embodiment, the method for power control based on wireless signal technology includes:

S1: Transmit a composite microwave signal to a target area by using a pre-configured phased array, and then receive an echo signal reflected back from the target area to obtain an original environmental reflection signal; and perform high-frequency harmonic component stripping processing on the original environmental reflection signal to obtain an electromagnetic characteristic signal.

In the embodiment of this disclosure, the original environmental reflection signal is obtained by transmitting the composite microwave signal to the target area using the pre-configured phased array, and then receiving the echo signal reflected back from the target area, so that electromagnetic information of the target area can be collected, especially the environmental information around the power supply device, providing reliable data for subsequent power control analysis.

The pre-configured phased array refers to a phased array antenna system in which parameters (such as the arrangement of line elements, beam scanning range, transmission power, and other parameters) are preset. The phased array antenna system is composed of a plurality of antenna units, and pointing control and shape adjustment of a beam can be achieved by controlling a signal phase and amplitude of each unit.

The composite microwave signal refers to a signal formed by combining a plurality of microwave signals with different frequencies, phases, and amplitudes; the target area refers to a specific spatial range where power control needs to be performed; and the original environmental reflection signal refers to the signal reflected back from the target area and received by the phased array.

Optional, the original environmental reflection signal can be obtained by the pre-configured phased array, sending a composite microwave signal to the target area according to a preset transmission mode and power, while using a receiving function of the phased array to collect the echo reflected back from the target area.

In the embodiment of this disclosure, the high-frequency harmonic component stripping processing is performed on the original environmental reflection signal to obtain an electromagnetic characteristic signal, so that the original signal can be purified, a signal part reflecting an intrinsic electromagnetic characteristic of the target area is highlighted, and the accuracy of signal analysis for an original environmental area can be improved.

The electromagnetic characteristic signal refers to a signal including electromagnetic information related to a position, a material, a structure, and the like of an object (e.g., a power supply device) in the target area.

As an embodiment of this disclosure, the performing high-frequency harmonic component stripping processing on the original environmental reflection signal to obtain an electromagnetic characteristic signal includes: performing band-pass filtering processing on the original environmental reflection signal to obtain a baseband purification signal; performing second-order intermodulation distortion elimination processing on the baseband purification signal to obtain an intermodulation suppression signal; performing third-order intermodulation interference elimination processing on the intermodulation suppression signal to obtain an intermodulation compensation signal; performing nonlinear residual compensation on the intermodulation compensation signal to obtain an enhanced signal; and performing harmonic component reconstruction on the enhanced signal to obtain the electromagnetic characteristic signal.

The baseband purification signal refers to a clean signal obtained by filtering out high-frequency and low-frequency interference signals outside a specific passband range from the original signal and retaining useful signal components in the target frequency band. The intermodulation suppression signal refers to a signal obtained by eliminating the second-order intermodulation distortion generated when the baseband purification signal passes through nonlinear elements during transmission. The intermodulation compensation signal refers to a signal obtained by performing third-order intermodulation interference elimination processing on the intermodulation suppression signal.

Optional, the baseband purification signal can be obtained by performing band-pass filtering processing on the original environmental reflection signal by using a FIR filter bank. The intermodulation suppression signal can be obtained by applying adaptive filtering technology (e.g., least mean square algorithm) to continuously iteratively update a filter coefficient corresponding to the baseband purification signal and gradually eliminate the impact of second-order intermodulation distortion on the signal. The intermodulation compensation signal can be obtained by performing spectrum analysis on the intermodulation suppression signal by using a spectrum analysis-based method to identify a frequency component and an amplitude of the third-order intermodulation interference, followed by generating a compensation signal by using digital signal processing technology. The enhanced signal can be obtained by establishing a nonlinear residual model by using a neural network and then performing signal compensation on the intermodulation compensation signal. The performing harmonic component reconstruction on the enhanced signal to obtain the electromagnetic characteristic signal can be achieved by using a fast Fourier transform technology.

S2: Perform multipath delay analysis on the electromagnetic characteristic signal to identify a direct wave component and a reflected wave component of the electromagnetic characteristic signal; and calculate, based on the direct wave component and the reflected wave component, a signal propagation delay and a signal attenuation coefficient of the electromagnetic characteristic signal in a signal transmission path.

In the embodiment of this disclosure, the multipath delay analysis is performed on the electromagnetic characteristic signal to identify a direct wave component and a reflected wave component of the electromagnetic characteristic signal, which can help the user understand the direct propagation of the signal from a transmitting end to the target area and then back, as well as a complex propagation paths of the signal in the environment.

The direct wave component refers to an electromagnetic wave signal component that propagates directly from the signal transmitting end to the receiving end. The reflected wave component refers to an electromagnetic wave signal component that reaches the receiving end after the electromagnetic signal is reflected when encountering various objects (e.g., the ground, buildings, obstacles, etc.) during transmission.

As an embodiment of this disclosure, the performing multipath delay analysis on the electromagnetic characteristic signal to identify a direct wave component and a reflected wave component of the electromagnetic characteristic signal includes: performing a short-time Fourier transform on the electromagnetic characteristic signal to obtain a time-frequency matrix; constructing a sparse dictionary of the electromagnetic characteristic signal based on the time-frequency matrix; performing sparse reconstruction on a multipath component in the sparse dictionary to obtain a sparse coefficient vector; and identifying the direct wave component and the reflected wave component of the electromagnetic characteristic signal according to the sparse coefficient vector.

The time-frequency matrix refers to a two-dimensional matrix used for representing the distribution characteristics of a signal in both the time and frequency dimensions. The sparse dictionary refers to a matrix composed of a group of basis functions or atoms, and is used for sparse representation of the signal. The sparse coefficient vector refers to a vector related to the sparse dictionary, which includes a representation coefficient of the signal under the sparse dictionary.

Optional, the time-frequency matrix can be obtained by segmenting the electromagnetic characteristic signal into a plurality of short time periods, performing a short-time Fourier transform on the signal in each short time period to analyze a frequency component of the signal within that time period, and then combining frequency spectrum results corresponding to each short time period. The sparse dictionary can be obtained by analyzing the characteristic of different time-frequency points in the time-frequency matrix, selecting an appropriate basis function (e.g., a discrete Fourier basis, a wavelet basis, etc.) according to the signal characteristic and the multipath component situation, and then combining these basis functions to construct a dictionary matrix capable of representing various multipath components in the electromagnetic characteristic signal. The sparse coefficient vector can be obtained by projecting the electromagnetic characteristic signal onto the sparse dictionary, and then using a sparse reconstruction algorithm to query a coefficient vector that can determine the electromagnetic characteristic signal with a minimum combination of basis functions. The direct wave component and the reflected wave component can be identified by analyzing a basis function corresponding to each element in the sparse coefficient vector (different basis functions represent different multipath components) in combination with prior knowledge and a signal propagation model, and then determined according to the characteristic of the basis function and the magnitude of the coefficient. For example, the direct wave usually has the shortest propagation path, and the corresponding basis function generally has a specific time-frequency characteristic and a relatively large coefficient value, and specifically, it needs to be analyzed and determined in combination with practical applications. Further, in the embodiment of this disclosure, the signal propagation delay and the signal attenuation coefficient of the electromagnetic characteristic signal in the signal transmission path are calculated based on the direct wave component and the reflected wave component, so that the time spent by the signal in the entire transmission process can be understood through the signal propagation delay, which can help the user determine a distance of the target area; and the signal attenuation coefficient can help the user select parameters such as transmission power and antenna gain to ensure that the signal has sufficient intensity in the target area and guarantee the quality and stability of communication.

The signal propagation delay refers to a time interval experienced by the signal from the transmitting end to the receiving end. The signal attenuation coefficient refers to a parameter that measures the degree of energy attenuation of the signal during transmission.

As an embodiment of this disclosure, the calculating, based on the direct wave component and the reflected wave component, a signal propagation delay and a signal attenuation coefficient of the electromagnetic characteristic signal in a signal transmission path includes: performing peak detection on the direct wave component and the reflected wave component to obtain a direct wave arrival time and a reflected wave arrival time; and calculating, based on the direct wave arrival time and the reflected wave arrival time, the signal propagation delay of the electromagnetic characteristic signal in the signal transmission path by using the following formula:

T=w_{d}×(t_{d}−t₀)+wᵣ×(tᵣ−t₀)
where T represents the signal propagation delay; w_{d} represents a weight of the direct wave component; wᵣ represents a weight of the reflected wave component; t₀ represents a transmission time of the electromagnetic characteristic signal; t_{d} represents the direct wave arrival time; and tᵣ represents the reflected wave arrival time;
calculating a signal attenuation coefficient of the direct wave component by using the following formula to obtain a first signal attenuation coefficient:

$${α}_{d} = 10 {log}_{10} ( \frac{{P}_{t}}{{P}_{rd}} ) - P ( d )$$

where α_{d} represents the first signal attenuation coefficient; Pₜ represents power of a transmitted signal corresponding to the direct wave component; P_{rd} represents received power of the direct wave component; P(d) represents path loss of the direct wave component;
calculating a signal attenuation coefficient of the reflected wave component by using the following formula to obtain a second signal attenuation coefficient:

$${α}_{r} = 10 {log}_{10} ( \frac{{P}_{t}}{{P}_{rr}} ) - P ( r )$$

where αᵣ represents the second signal attenuation coefficient; Pₜ represents power of a transmitted signal corresponding to the direct wave component; Pᵣᵣ represents received power of the reflected wave component; P(r) represents path loss of the reflected wave component; and
performing weighting processing on the first signal attenuation coefficient and the second signal attenuation coefficient to determine the signal attenuation coefficient of the electromagnetic characteristic signal in the signal transmission path.

Optional, the implementation process of performing peak detection on the direct wave component and the reflected wave component to obtain a direct wave arrival time and a reflected wave arrival time is as follows: a signal processing algorithm, such as peak detection technology based on sliding window comparison, is used to traverse the signal data of the direct wave and reflected wave components, determine a moment when the signal amplitude reaches a peak, thereby obtaining the direct wave arrival time and the reflected wave arrival time. The signal attenuation coefficient can be obtained by determining weighting coefficients for the first and second signal attenuation coefficients according to the importance of the direct wave and reflected wave components in the overall signal (e.g., the direct wave is more important, which can be set to 0.6, and the reflected wave is set to 0.4), and then performing a weighted summation calculation on the first and second signal attenuation coefficients.

It should be further noted that, the above signal propagation delay calculation formula calculates the propagation delay based on the arrival times of the direct wave and the reflected wave as well as their respective weights, while incorporating the signal transmission time, which can accurately obtain the propagation time delay of the electromagnetic characteristic signal in the transmission path. The first signal attenuation coefficient calculation formula calculates the attenuation coefficient through transmitted signal power, received power, and path loss of the direct wave component, which can quantify the degree of signal attenuation of the direct wave component during transmission; and the second signal attenuation coefficient calculation formula calculates the attenuation coefficient based on transmitted signal power, received power, and path loss of the reflected wave component, which can clarify the signal attenuation situation of the reflected wave component during transmission.

S3: Construct a three-dimensional electromagnetic field model of the target area based on the signal propagation delay and the signal attenuation coefficient; identify a harmonic characteristic of a power supply device in the target area by using the three-dimensional electromagnetic field model; detect and monitor a backscatter signal of the power supply device in real time based on the harmonic characteristic; analyze an energy absorption characteristic of the power supply device based on the backscatter signal; and construct an energy consumption demand curve of the power supply device based on the energy absorption characteristic.

In the embodiment of this disclosure, the three-dimensional electromagnetic field model of the target area is constructed based on the signal propagation delay and the signal attenuation coefficient, so that the electromagnetic field distribution in the target area can be accurately modeled in a three-dimensional space, thereby further analyzing characteristics such as the intensity and phase of the electromagnetic field at each point in the target area.

The three-dimensional electromagnetic field model refers to.

As an embodiment of this disclosure, the constructing a three-dimensional electromagnetic field model of the target area based on the signal propagation delay and the signal attenuation coefficient includes: converting the target area into a three-dimensional voxel grid; reconstructing a propagation path of the target area based on the three-dimensional voxel grid to obtain a reconstructed path set; performing environmental CAD matching on the reconstructed path set to obtain a matched path set; calculating, by using the signal propagation delay and the signal attenuation coefficient, a field intensity distribution of different matched paths in the matched path set to obtain a field intensity matrix; constructing a three-dimensional heat map of the target area based on the field intensity matrix; and performing digital twin processing on the three-dimensional heat map to obtain the three-dimensional electromagnetic field model.

The three-dimensional voxel grid refers to a unit structure that divides a three-dimensional space into numerous small, regularly shaped (typically cubic) units, where each unit is called a voxel. The field intensity matrix refers to a matrix composed of electromagnetic field intensity values, whose elements correspond to electromagnetic field intensity information at different position points in the space.

Optional, the three-dimensional voxel grid can be obtained by dividing the target area into numerous small three-dimensional voxels by using three-dimensional modeling technology. The reconstructed path set can be obtained by applying a ray tracing algorithm and combining it with the structural information of the three-dimensional voxel grid to simulate a propagation path of an electromagnetic wave in the target area. The matched path set can be obtained by comparing the reconstructed path set with the environmental CAD model of the target area, and screening out the path meeting the actual environment through characteristic matching and spatial position matching technology. The field intensity matrix is obtained by calculating the field intensity at each point on different paths in the matched path set by using an electromagnetic propagation theory formula based on the signal propagation delay and the signal attenuation coefficient, and then converting the calculated field intensity into a matrix. The three-dimensional heat map can be constructed by using visualization technology based on a field intensity value of each point in the field intensity matrix.

Further, in the embodiment of this disclosure, the harmonic characteristic of the power supply device in the target area is identified by using the three-dimensional electromagnetic field model, so that the power supply device can be accurately distinguished from a complex electromagnetic environment, and its working state can be understood.

The harmonic characteristic refers to the properties presented by the harmonic component other than a fundamental wave in the signal, such as a frequency characteristic, an amplitude characteristic, and a phase characteristic.

As an embodiment of this disclosure, the identifying a harmonic characteristic of a power supply device in the target area by using the three-dimensional electromagnetic field model includes: performing coordinate matching between the three-dimensional electromagnetic field model and the power supply device in the target area to obtain a device coordinate set; identifying a spectrum characteristic of the device coordinate set at a position corresponding to the three-dimensional electromagnetic field model; performing characteristic matching between the spectrum characteristic and a pre-configured device fingerprint database to obtain a matched characteristic; and identifying the harmonic characteristic of the power supply device in the target area based on the matched characteristic.

The pre-configured device fingerprint database refers to a pre-established database used for storing characteristic information of various power supply devices, and the characteristic information, like a “fingerprint” of a device, has uniqueness and identifiability.

Optional, the device coordinate set can be obtained by calibrating and matching a coordinate system of the three-dimensional electromagnetic field model with coordinates of the actual installation position of the power supply device by using Geographic Information System (GIS) technology. The spectrum characteristic is obtained by performing spectrum analysis on the position corresponding to the device coordinates in the three-dimensional electromagnetic field model by using the fast Fourier transform. The matched characteristic can be obtained by comparing the extracted spectrum characteristic with characteristics in the pre-configured device fingerprint database by using a support vector machine algorithm, finding a feature with the highest similarity. The harmonic characteristic can be queried and determined from the device fingerprint database based on a correspondence between the matched characteristic and the device harmonic characteristic.

Further, in an embodiment of the present invention, the backscatter signal of the power supply device is detected and monitored in real time based on the harmonic characteristic, so that dynamic information of the power supply device at different times can be obtained, thereby timely capturing a change in the operating state of the power supply device.

The backscatter signal refers to the part of the electromagnetic wave signal that when an electromagnetic wave irradiates an object, a portion of the incident electromagnetic wave is scattered by the object in various directions, where the scattered direction is opposite to that of the incident wave.

Optional, the backscatter signal can be obtained by receiving the reflected signal of the device in a harmonic frequency band through a directional antenna.

In an embodiment of the present invention, the energy absorption characteristic of the power supply device is analyzed based on the backscatter signal, so that the utilization efficiency and consumption of electric energy by the power supply device can be understood.

The energy absorption characteristic refers to a series of characteristics presented by an object or a system during the energy absorption process, and these characteristics can help people understand the absorption, conversion, and dissipation of energy in the object or the system.

As an embodiment of this disclosure, the analyzing an energy absorption characteristic of the power supply device based on the backscatter signal includes: performing direct current component removal processing on the backscatter signal to obtain a direct current removed signal; identifying a frequency domain characteristic and a time domain characteristic of the direct current removed signal; analyzing, based on the frequency domain characteristic, an absorption response of the power supply device to electromagnetic waves of different frequencies to obtain a frequency absorption characteristic; constructing an energy absorption model of the power supply device based on the time domain characteristic; analyzing energy absorption efficiency of the power supply device under different working conditions by using the energy absorption model; and identifying the energy absorption characteristic of the power supply device based on the frequency absorption characteristic and the energy absorption efficiency.

The frequency absorption characteristic refers to an absorption characteristic of a power supply device for electromagnetic waves of different frequencies, including aspects such as the strength of the absorption capacity for a specific frequency, a frequency range of absorption, and an absorption selectivity. The energy absorption model refers to a mathematical model or a physical model used for describing the energy absorption process and law of the power supply device. The energy absorption efficiency refers to a ratio of the energy absorbed by the power supply device to a total energy incident to the device.

Optional, the direct current removed signal can be obtained by using high-pass filtering technology to set an appropriate cutoff frequency, allowing an alternating current signal to pass through and blocking a direct current component, thereby removing a direct current component from the backscatter signal. The frequency domain characteristic can be identified by converting the direct current removed signal to a frequency domain by using the fast Fourier transform, and the time domain characteristic can be obtained by performing pulse width measurement on the direct current removed signal. The frequency absorption characteristic can be obtained by comparing signal amplitudes corresponding to electromagnetic waves of different frequencies based on amplitude changes of each frequency component in the frequency domain characteristic, and analyzing the absorption of electromagnetic waves of different frequencies by the power supply device. The energy absorption model can be obtained by constructing a mathematical model describing the energy absorption of the power supply device through methods such as regression analysis, using time domain characteristic (e.g., signal peak, pulse width, etc.) combined with a working principle of the power supply device. The energy absorption efficiency can be determined by inputting different working condition parameters of the power supply device into the energy absorption model, calculating the output results based on the model, comparing the input energy with the absorbed energy, and obtaining the absorption efficiency under different working conditions. The energy absorption characteristic can be identified by comprehensively analyzing the frequency selectivity presented by the absorption responses at different frequencies and the overall energy absorption level reflected by the energy absorption efficiency.

Further, in the embodiment of this disclosure, the energy consumption demand curve of the power supply device is constructed based on the energy absorption characteristic, so that a change low of the energy consumption of the power supply device with time or other factors (e.g., load changes, environment temperature, etc.) can be intuitively displayed, thereby providing a basis for power supply and the operation scheduling of the device.

The energy consumption demand curve refers to a curve used for describing a variation trend of energy consumption with time or other related variables.

As an embodiment of this disclosure, the constructing an energy consumption demand curve of the power supply device based on the energy absorption characteristic includes: performing time series alignment processing on the energy absorption characteristic to obtain a time series absorption characteristic; performing working condition segmentation labeling processing on the time series absorption characteristic to obtain a labeled characteristic; performing, based on the labeled characteristic, vectorization processing on the labeled characteristic to obtain a labeled matrix; constructing an energy consumption demand prediction model of the power supply device by using the labeled matrix; analyzing a future energy consumption distribution of the power supply device based on the energy consumption demand prediction model; and constructing the energy consumption demand curve of the power supply device based on the future energy consumption distribution.

The energy consumption demand prediction model refers to a model established based on mathematical and statistical principles, which is used for predicting the energy consumption of power supply device under different conditions.

Optional, the time series absorption characteristic can be obtained by applying a timestamp synchronization algorithm, and arranging the energy absorption characteristic data collected in different time periods on a unified time scale according to the operation start time of the power supply device. The labeled characteristic is obtained by dividing and marking the time series absorption characteristic according to different working conditions (e.g., light load, full load, etc.) with reference to the working manual of the power supply device and historical operation data. The labeled matrix can be obtained by converting various labeled characteristics into computer-recognizable numerical vectors by using one-hot encoding, and then arranging and constructing the matrix according to row and column rules. The energy consumption demand prediction model can be built by applying machine learning algorithms such as linear regression and neural networks (e.g., recurrent neural network), taking the labeled matrix as input, and performing model training by associating historical energy consumption data. The future energy consumption distribution can be determined by converting an expected working condition of the power supply device in the future time period into a labeled matrix format, inputting the labeled matrix format into the energy consumption demand prediction model, and calculating the energy consumption values at different time points. The energy consumption demand curve can be obtained by taking time as a horizontal axis, using the energy consumption values in the future energy consumption distribution as a vertical axis, and drawing a smooth curve with drawing software (e.g., Matplotlib).

S4: Optimize, based on the energy consumption demand curve, a power supply time series scheme for the power supply device to obtain a multi-target load distribution strategy for the power supply device; perform parameter adjustment on the pre-configured phased array based on the multi-target load distribution strategy to obtain an adjusted signal device; and perform power control on the power supply device by using the adjusted signal device.

In an embodiment of the present invention, the power supply time series scheme for the power supply device is optimized based on the energy consumption demand curve to obtain a multi-target load distribution strategy for the power supply device, so that the reasonable distribution of different loads can be achieved, ensuring that each load meets the working requirement while the overall system performance reaches the optimal level.

The multi-target load distribution strategy refers to a strategy system that comprehensively considers a plurality of interrelated and potentially conflicting targets to scientifically plan and distribute the load of the power supply device.

As an embodiment of this disclosure, the optimizing, based on the energy consumption demand curve, a power supply time series scheme for the power supply device to obtain a multi-target load distribution strategy for the power supply device includes: segmenting the energy consumption demand curve to obtain a segmented curve; performing overload detection on the segmented curve to obtain an overload curve; performing load adjustment on the overload curve to obtain an adjusted curve; constructing a preliminary load distribution strategy of the power supply device based on the adjusted curve; identifying an operation constraint and a power supply requirement of the power supply device; and optimizing, based on the operation constraint and the power supply requirement, the preliminary load distribution strategy to obtain the multi-target load distribution strategy.

The overload curve refers to a curve formed by performing overload detection on each segmented curve by setting an overload threshold after segmenting the energy consumption demand curve, and marking the parts where the energy consumption value exceeds the threshold. The adjusted curve refers to a curve obtained after load reduction is performed on the overload curve. The operation constraint refers to various limiting conditions experienced by the power supply device during operation, including technical parameter limitations of the device itself, such as maximum power, minimum operating time, maximum current, voltage range, etc. The power supply requirement refers to various requirements proposed by an electric device or a system for the power supply device in terms of power supply.

Optional, the segmented curve can be obtained by dividing the continuous energy consumption demand curve into a plurality of small segments with similar characteristics by using a data segmentation algorithm (e.g., sliding window method) according to time intervals or an energy consumption variation characteristic. The overload curve can be obtained by setting a reasonable overload threshold, traversing each segmented curve, comparing the energy consumption value of each time period with the threshold, and marking the parts where the energy consumption exceeds the threshold by using threshold comparison technology. The adjusted curve can be obtained by targeting the overload curve part, using load transfer or power regulation technology to transfer part of the load in the overload period to an energy consumption valley period, or reducing the power of the overloaded load. The preliminary load distribution strategy can be obtained by taking the adjusted curve as a basis, applying a resource distribution algorithm according to the adjusted energy consumption distribution of each time period, and determining an approximate distribution scheme of various loads in different time periods. The operation constraint and power supply requirement of the power supply device can be obtained by consulting the technical manual of the power supply device, combining the actual operating environment, and analyzing and sorting out the limiting conditions of the device operation (e.g., maximum power, minimum operating time, etc.) and requirements in terms of power supply (e.g., voltage stability, power supply continuity, etc.). The multi-target load distribution strategy can be obtained by applying a multi-target optimization algorithm (e.g., genetic algorithm, particle swarm optimization algorithm), taking the operation constraint and power supply requirement as the constraint condition, and taking power supply cost, device lifetime, energy utilization rate, etc. as optimization targets to iteratively optimize the preliminary load distribution strategy.

Further, in the embodiment of this disclosure, the parameter adjustment on the pre-configured phased array is performed based on the multi-target load distribution strategy to obtain an adjusted signal device, so that the signal emitted by the phased array can control the operating state of the power supply device more accurately, thereby achieving effective distribution of loads.

Optional, the adjusted signal device can be obtained by automatically adjusting a transmission direction and power of the phased array antenna according to the power supply priority and position of each device.

Still further, in the embodiment of this disclosure, power control is performed on the power supply device by using the adjusted signal device, so that refined control of the power supply device can be achieved, ensuring the efficient and stable operation of the power supply device, and further improving the performance and efficiency of the entire power system.

Optional, the performing power control on the power supply device by using the adjusted signal device can be achieved by matching the device position and the energy consumption demand in real time, and dynamically controlling the direction, power, and time series of the phased array beam.

### Embodiment 2

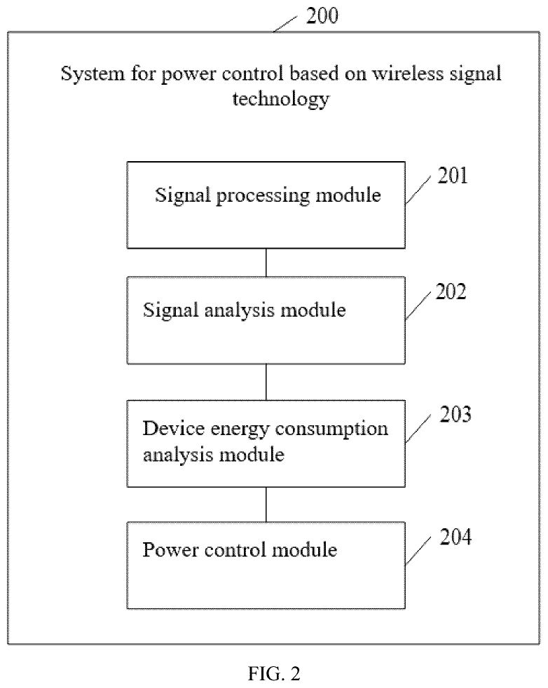

As shown in FIG. 2, it is a functional module diagram of a system for power control based on wireless signal technology according to this disclosure.

The system 200 for power control based on wireless signal technology according to this disclosure can be installed in an electronic device. According to the implemented functions, the system for power control based on wireless signal technology may include a signal processing module 201, a signal analysis module 202, a device energy consumption analysis module 203, and a power control module 204. The modules described in this disclosure may also be referred to as units, which refer to a series of computer program segments that can be executed by a processor of the electronic device and can complete a fixed function, and are stored in a memory of the electronic device.

In the embodiment of this disclosure, the functions of each module/unit are as follows:
the signal processing module 201 is configured to transmit a composite microwave signal to a target area by using a pre-configured phased array, and then receive an echo signal reflected back from the target area to obtain an original environmental reflection signal; and perform high-frequency harmonic component stripping processing on the original environmental reflection signal to obtain an electromagnetic characteristic signal;
the signal analysis module 202 is configured to perform multipath delay analysis on the electromagnetic characteristic signal to identify a direct wave component and a reflected wave component of the electromagnetic characteristic signal; and calculate, based on the direct wave component and the reflected wave component, a signal propagation delay and a signal attenuation coefficient of the electromagnetic characteristic signal in a signal transmission path;
the device energy consumption analysis module 203 is configured to construct a three-dimensional electromagnetic field model of the target area based on the signal propagation delay and the signal attenuation coefficient; identify a harmonic characteristic of a power supply device in the target area by using the three-dimensional electromagnetic field model; detect and monitor a backscatter signal of the power supply device in real time based on the harmonic characteristic; analyze an energy absorption characteristic of the power supply device based on the backscatter signal; and construct an energy consumption demand curve of the power supply device based on the energy absorption characteristic; and
the power control module 204 is configured to optimize, based on the energy consumption demand curve, a power supply time series scheme for the power supply device to obtain a multi-target load distribution strategy for the power supply device; perform parameter adjustment on the pre-configured phased array based on the multi-target load distribution strategy to obtain an adjusted signal device; and perform power control on the power supply device by using the adjusted signal device.

In detail, during use, each module in the system 200 for power control based on wireless signal technology described in the embodiment of this disclosure adopts the same technical means as the method for power control based on wireless signal technology described in FIG. 1, and can achieve the same technical effect, which is not described in detail herein again.

It will be apparent to those skilled in the art that this disclosure is not limited to the details of the above exemplary embodiments, and that this disclosure can be embodied in other specific forms without departing from the spirit or essential characteristics of this disclosure.

Finally, it should be noted that the foregoing embodiments are merely intended to describe the technical solutions of this disclosure, but not intended to constitute any limitation. Although this disclosure is described in detail with reference to preferred embodiments, it will be understood by those of ordinary skill in the art that modifications or equivalent substitutions may be made to the technical solutions of this disclosure without departing from the spirit and scope of the technical solutions of this disclosure.

What is claimed is:

1. A method for power control based on wireless signal technology, wherein the method comprises:
transmitting a composite microwave signal to a target area by using a pre-configured phased array, and then receiving an echo signal reflected back from the target area to obtain an original environmental reflection signal; and performing high-frequency harmonic component stripping processing on the original environmental reflection signal to obtain an electromagnetic characteristic signal;
performing multipath delay analysis on the electromagnetic characteristic signal to identify a direct wave component and a reflected wave component of the electromagnetic characteristic signal; and calculating, based on the direct wave component and the reflected wave component, a signal propagation delay and a signal attenuation coefficient of the electromagnetic characteristic signal in a signal transmission path;
constructing a three-dimensional electromagnetic field model of the target area based on the signal propagation delay and the signal attenuation coefficient; identifying a harmonic characteristic of a power supply device in the target area by using the three-dimensional electromagnetic field model; detecting and monitoring a backscatter signal of the power supply device in real time based on the harmonic characteristic; analyzing an energy absorption characteristic of the power supply device based on the backscatter signal; and constructing an energy consumption demand curve of the power supply device based on the energy absorption characteristic; and
optimizing, based on the energy consumption demand curve, a power supply time series scheme for the power supply device to obtain a multi-target load distribution strategy for the power supply device; performing parameter adjustment on the pre-configured phased array based on the multi-target load distribution strategy to obtain an adjusted signal device; and performing power control on the power supply device by using the adjusted signal device.

2. The method for power control based on wireless signal technology according to claim 1, wherein the performing high-frequency harmonic component stripping processing on the original environmental reflection signal to obtain an electromagnetic characteristic signal comprises:
performing band-pass filtering processing on the original environmental reflection signal to obtain a baseband purification signal;
performing second-order intermodulation distortion elimination processing on the baseband purification signal to obtain an intermodulation suppression signal;
performing third-order intermodulation interference elimination processing on the intermodulation suppression signal to obtain an intermodulation compensation signal;
performing nonlinear residual compensation on the intermodulation compensation signal to obtain an enhanced signal; and
performing harmonic component reconstruction on the enhanced signal to obtain the electromagnetic characteristic signal.

3. The method for power control based on wireless signal technology according to claim 1, wherein the performing multipath delay analysis on the electromagnetic characteristic signal to identify a direct wave component and a reflected wave component of the electromagnetic characteristic signal comprises:
performing a short-time Fourier transform on the electromagnetic characteristic signal to obtain a time-frequency matrix;
constructing a sparse dictionary of the electromagnetic characteristic signal based on the time-frequency matrix;
performing sparse reconstruction on a multipath component in the sparse dictionary to obtain a sparse coefficient vector; and
identifying the direct wave component and the reflected wave component of the electromagnetic characteristic signal according to the sparse coefficient vector.

4. The method for power control based on wireless signal technology according to claim 1, wherein the calculating, based on the direct wave component and the reflected wave component, a signal propagation delay and a signal attenuation coefficient of the electromagnetic characteristic signal in a signal transmission path comprises:
performing peak detection on the direct wave component and the reflected wave component to obtain a direct wave arrival time and a reflected wave arrival time;
calculating, based on the direct wave arrival time and the reflected wave arrival time, the signal propagation delay of the electromagnetic characteristic signal in the signal transmission path by using the following formula:
T=w_{d}×(t_{d}−t₀)+wᵣ×(tᵣ−t₀)
wherein T represents the signal propagation delay; w_{d} represents a weight of the direct wave component; wᵣ represents a weight of the reflected wave component; t₀ represents a transmission time of the electromagnetic characteristic signal; t_{d} represents the direct wave arrival time; and tᵣ represents the reflected wave arrival time;
calculating a signal attenuation coefficient of the direct wave component by using the following formula to obtain a first signal attenuation coefficient:
$${α}_{d} = 10 {log}_{10} ( \frac{{P}_{t}}{{P}_{rd}} ) - P ( d )$$
wherein α_{d} represents the first signal attenuation coefficient; Pₜ represents power of a transmitted signal corresponding to the direct wave component; P_{rd} represents received power of the direct wave component; P(d) represents path loss of the direct wave component;
calculating a signal attenuation coefficient of the reflected wave component by using the following formula to obtain a second signal attenuation coefficient:
$${α}_{r} = 10 {log}_{10} ( \frac{{P}_{t}}{{P}_{rr}} ) - P ( r )$$
wherein αᵣ represents the second signal attenuation coefficient; Pₜ represents power of a transmitted signal corresponding to the direct wave component; Pᵣᵣ represents received power of the reflected wave component; P(r) represents path loss of the reflected wave component; and
performing weighting processing on the first signal attenuation coefficient and the second signal attenuation coefficient to determine the signal attenuation coefficient of the electromagnetic characteristic signal in the signal transmission path.

5. The method for power control based on wireless signal technology according to claim 1, wherein the constructing a three-dimensional electromagnetic field model of the target area based on the signal propagation delay and the signal attenuation coefficient comprises:
converting the target area into a three-dimensional voxel grid;
reconstructing a propagation path of the target area based on the three-dimensional voxel grid to obtain a reconstructed path set;
performing environmental CAD matching on the reconstructed path set to obtain a matched path set;
calculating, by using the signal propagation delay and the signal attenuation coefficient, a field intensity distribution of different matched paths in the matched path set to obtain a field intensity matrix;
constructing a three-dimensional heat map of the target area based on the field intensity matrix; and
performing digital twin processing on the three-dimensional heat map to obtain the three-dimensional electromagnetic field model.

6. The method for power control based on wireless signal technology according to claim 1, wherein the identifying a harmonic characteristic of a power supply device in the target area by using the three-dimensional electromagnetic field model comprises:
performing coordinate matching between the three-dimensional electromagnetic field model and the power supply device in the target area to obtain a device coordinate set;
identifying a spectrum characteristic of the device coordinate set at a position corresponding to the three-dimensional electromagnetic field model;
performing characteristic matching between the spectrum characteristic and a pre-configured device fingerprint database to obtain a matched characteristic; and
identifying the harmonic characteristic of the power supply device in the target area based on the matched characteristic.

7. The method for power control based on wireless signal technology according to claim 1, wherein the analyzing an energy absorption characteristic of the power supply device based on the backscatter signal comprises:
performing direct current component removal processing on the backscatter signal to obtain a direct current removed signal;
identifying a frequency domain characteristic and a time domain characteristic of the direct current removed signal;
analyzing, based on the frequency domain characteristic, an absorption response of the power supply device to electromagnetic waves of different frequencies to obtain a frequency absorption characteristic;
constructing an energy absorption model of the power supply device based on the time domain characteristic;
analyzing energy absorption efficiency of the power supply device under different working conditions by using the energy absorption model; and
identifying the energy absorption characteristic of the power supply device based on the frequency absorption characteristic and the energy absorption efficiency.

8. The method for power control based on wireless signal technology according to claim 1, wherein the constructing an energy consumption demand curve of the power supply device based on the energy absorption characteristic comprises:
performing time series alignment processing on the energy absorption characteristic to obtain a time series absorption characteristic;
performing working condition segmentation labeling processing on the time series absorption characteristic to obtain a labeled characteristic;
performing, based on the labeled characteristic, vectorization processing on the labeled characteristic to obtain a labeled matrix;
constructing an energy consumption demand prediction model of the power supply device by using the labeled matrix;
analyzing a future energy consumption distribution of the power supply device based on the energy consumption demand prediction model; and
constructing the energy consumption demand curve of the power supply device based on the future energy consumption distribution.

9. The method for power control based on wireless signal technology according to claim 1, wherein the optimizing, based on the energy consumption demand curve, a power supply time series scheme for the power supply device to obtain a multi-target load distribution strategy for the power supply device comprises:
segmenting the energy consumption demand curve to obtain a segmented curve;
performing overload detection on the segmented curve to obtain an overload curve;
performing load adjustment on the overload curve to obtain an adjusted curve;
constructing a preliminary load distribution strategy of the power supply device based on the adjusted curve;
identifying an operation constraint and a power supply requirement of the power supply device; and
optimizing, based on the operation constraint and the power supply requirement, the preliminary load distribution strategy to obtain the multi-target load distribution strategy.

10. A system for power control based on wireless signal technology, wherein the system comprises:
a signal processing module, configured to transmit a composite microwave signal to a target area by using a pre-configured phased array, and then receive an echo signal reflected back from the target area to obtain an original environmental reflection signal; and perform high-frequency harmonic component stripping processing on the original environmental reflection signal to obtain an electromagnetic characteristic signal;
a signal analysis module, configured to perform multipath delay analysis on the electromagnetic characteristic signal to identify a direct wave component and a reflected wave component of the electromagnetic characteristic signal; and calculate, based on the direct wave component and the reflected wave component, a signal propagation delay and a signal attenuation coefficient of the electromagnetic characteristic signal in a signal transmission path;
a device energy consumption analysis module, configured to construct a three-dimensional electromagnetic field model of the target area based on the signal propagation delay and the signal attenuation coefficient; identify a harmonic characteristic of a power supply device in the target area by using the three-dimensional electromagnetic field model; detect and monitor a backscatter signal of the power supply device in real time based on the harmonic characteristic; analyze an energy absorption characteristic of the power supply device based on the backscatter signal; and construct an energy consumption demand curve of the power supply device based on the energy absorption characteristic; and
a power control module, configured to optimize, based on the energy consumption demand curve, a power supply time series scheme for the power supply device to obtain a multi-target load distribution strategy for the power supply device; perform parameter adjustment on the pre-configured phased array based on the multi-target load distribution strategy to obtain an adjusted signal device; and perform power control on the power supply device by using the adjusted signal device.
